(19) United States
(12) Patent Application Publication
(10) Pub. No.: US 2006/0288589 A1
(43) Pub. Date: Dec. 28, 2006

(54) Self-leveling spoon

(76) Inventor: Steven N. Verona, Margate City, NJ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/446,888

(22) Filed: Jun. 5, 2006

Related U.S. Application Data
(60) Provisional application No. 60/687,521, filed on Jun. 3, 2005.

(51) Int. Cl. A47J 43/28

(52) U.S. Cl. 30/324

(57) ABSTRACT

A self-leveling spoon that has a handle and a bowl mounted together with a rotary coupler. The center of gravity of the bowl is offset from the axis of rotation of the rotary coupler, and is preferably near the bottom of the bowl. This permits the bowl to always maintain a level orientation, regardless of whether the handle is rotated correctly, and regardless of whether the bowl is full or partially filled.

### BACKGROUND OF THE INVENTION

1. Field of the Invention

This invention relates generally to eating utensils.

2. Description of the Related Art

Spoons have a bowl and a connected handle that is normally held in the hand. It is well known that the bowl holds liquid or semi-liquid foods, and a person lifts the food to his mouth by hand. Some people have difficulty using spoons due to the lack of motor skills necessary to keep the bowl level. Thus, the contents thereof can be spilled. There is a need for a spoon that assists in maintaining the bowl level.

### (f) BRIEF SUMMARY OF THE INVENTION

The invention is a spoon including a hand-grippable handle, a rotary coupler mounted to the handle, and a bowl mounted to the rotary coupler. The bowl is relatively rotatably mounted to the handle through the rotary coupler, permitting the bowl to remain level even if the handle is rotated. In a preferred embodiment, the center of gravity of the bowl is offset from the axis of rotation of the rotary coupler, and is most preferably near the bottom of the bowl.

The center of gravity of the “bowl” is low enough that the bowl remains parallel with the ground regardless of the rotation of the handle. Thus, once filled, the bowl's rotary position is dependent upon the force of gravity, not the rotary position of the handle, to maintain the bowl level. The rotary coupler can be any coupler that permits rotary motion between two structures, including a simple bearing in which a shaft is rotatably mounted in a barrel in the manner of a door hinge, a coupler that uses ball bearings to form a much smoother bearing or an electromagnetic bearing.

The invention prevents users from spilling the contents of the spoon if the users are not able to rotate their hands and wrists in the manner required with conventional spoons. Examples of these users include children, the elderly, arthritis sufferers, and people with motor skill challenges.

### (g) BRIEF DESCRIPTION OF THE SEVERAL VIEWS OF THE DRAWINGS

FIG. 1 is a schematic side view illustrating the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

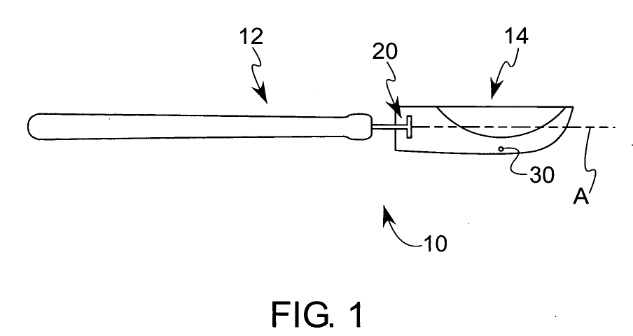

A spoon 10 made according to the present invention is shown in FIG. 1 having a handle 12 and a bowl 14. The handle 12 is designed to have a shape and size similar to a conventional spoon. The bowl 14 has a shape and size similar to conventional spoon bowls. The handle 12 and bowl 14 can be made of plastic, metal, composite or any suitable combination of materials.

A rotary coupler 20 is interposed between the bowl 14 and the handle 12. The rotary coupler 20 permits substantially free rotation of the bowl 14 relative to the handle 12. The rotary coupler 20 has a shaft around which the bowl's body extends. The bowl seats against the shaft with a low friction material, thereby forming a bearing that permits relative rotation of the bowl 14 and the handle 12. Of course, there are many other structures that can serve as the rotary coupler 20, including a ball-bearing and shaft arrangement, and many others. Any such configuration that permits substantially unrestricted movement of the bowl relative to the handle to accomplish the purpose of the invention can be used.

The center of gravity 30 of the bowl 14 is offset from the axis of rotation A of the rotary coupler 20, and is at or near the bottom of the bowl 14. The center of gravity of the bowl 14 is maintained at an offset position even when the bowl is partially or completely filled with matter. The bowl 14 tends to rotate about the rotary coupler 20 to maintain the bowl 14 at a level position due to the relative positions of the axis of rotation A and the center of gravity 30, even if the handle 12 is rotated. Thus, if a user, such as a child, raises a full bowl 14 of food to his mouth, but rotates the handle 12 as he raises it, the bowl 14 will not spill the food unless the spoon is tilted end-to-end. The spoon's bowl remains level due to rotation of the bowl 14 about the rotary coupler 20.

While certain preferred embodiments of the present invention have been disclosed in detail, it is to be understood that various modifications may be adopted without departing from the spirit of the invention or scope of the following claims.

1. A spoon comprising:
(a) a hand-grippable handle;
(b) a rotary coupler mounted to the handle; and
(c) a bowl mounted to the rotary coupler, said bowl being thereby relatively rotatably mounted to the handle through the rotary coupler.

2. The spoon in accordance with claim 1, wherein a center of gravity of the bowl is offset from an axis of rotation of the rotary coupler.

3. The spoon in accordance with claim 2, wherein the center of gravity of the bowl is near a bowl bottom.
